(19) United States
(12) Patent Application Publication
(10) Pub. No.: US 2025/0124731 A1
(43) Pub. Date: Apr. 17, 2025

(54) INFORMATION PROCESSING DEVICE, INFORMATION PROCESSING METHOD AND RECORDING MEDIUM

(71) Applicant: NEC Corporation, Tokyo (JP)

(72) Inventors: Yuki KOBAYASHI, Tokyo (JP); Tsuyoshi NAKAMURA, Tokyo (JP); Yoshikazu ARAI, Tokyo (JP); Kenichi UEDA, Tokyo (JP); Shinnosuke NiSHIMOTO, Tokyo (JP)

(73) Assignee: NEC Corporation, Tokyo (JP)

(21) Appl. No.: 18/903,087

(22) Filed: Oct. 1, 2024

(30) Foreign Application Priority Data
Oct. 11, 2023 (JP) 2023-175843

(51) Int. Cl. G06V 30/18; G06F 16/33

(52) U.S. Cl. CPC G06V 30/18143; G06F 16/3344

(57) ABSTRACT

The acquisition means acquires reader information and content information. The prompt generation means generates a prompt based on the reader information and the content information. The content editing means inputs the prompt into a large language model and acquire an output from the large language model as edited content.

### TECHNICAL FIELD

The present invention relates to a technique for editing content.

### BACKGROUND ART

Filtering techniques for not displaying content that contains inappropriate expressions such as violent expressions are known. For example, Patent Document 1 describes a technique for filtering video and/or audio media containing undesired content.

### PRECEDING TECHNICAL REFERENCES

### Patent Document

Patent Document 1: Japanese Patent Application Laid-Open under No. JP 2021-175187

### SUMMARY

### Problem to be Solved

Since the conventional filtering technique mainly performs filtering according to a predetermined rule, it is difficult to flexibly perform filtering according to a user's request.

It is an object of the present invention to provide an information processing device capable of editing content by reflecting user's information.

### Means for Solving the Problem

According to an example aspect of the present disclosure, there is provided an information processing device comprising:
an acquisition means configured to acquire reader information and content information;
a prompt generation means configured to generate a prompt based on the reader information and the content information; and
a content editing means configured to input the prompt into a large language model and acquire an output from the large language model as edited content.

According to another example aspect of the present disclosure, there is provided an information processing method comprising:
acquiring reader information and content information;
generating a prompt based on the reader information and the content information; and
inputting the prompt into a large language model and acquiring an output from the large language model as edited content.

According to still another example aspect of the present disclosure, there is provided a recording medium storing a program, the program causing a computer to execute processing of:
acquiring reader information and content information;
generating a prompt based on the reader information and the content information; and
inputting the prompt into a large language model and acquiring an output from the large language model as edited content.

### Effect

According to the present invention, it is possible to edit content by reflecting user's information.

### BRIEF DESCRIPTION OF THE DRAWINGS

FIG. 1 shows an overall configuration of a content editing system.

FIG. 2 is a block diagram showing a hardware configuration of an information processing device.

FIG. 3 is a block diagram showing a hardware configuration of a terminal device.

FIG. 4 is a block diagram showing a functional configuration of the information processing device.

FIG. 5 is an example of reader information.

FIG. 6 is an example of prompts.

FIGS. 7A and 7B show content before editing and content after editing.

FIG. 8 is a flowchart of content editing processing.

FIG. 9 shows an overall configuration of a content editing system 1a according to a modification.

FIG. 10 is a block diagram showing a functional configuration of an information processing device according to a second example embodiment.

FIG. 11 is an example of a document set.

FIG. 12 is a flowchart of content modification processing according to the second example embodiment.

FIG. 13 is a block diagram showing a functional configuration of an information processing device according to a third example embodiment.

FIG. 14 is a block diagram showing a functional configuration of an information processing device according to a fourth example embodiment.

FIG. 15 is a flowchart of processing by the information processing device according to the fourth example embodiment.

### EXAMPLE EMBODIMENTS

Preferred example embodiments of the present invention will be described with reference to the accompanying drawings.

### First Example Embodiment

### [Overall Configuration]

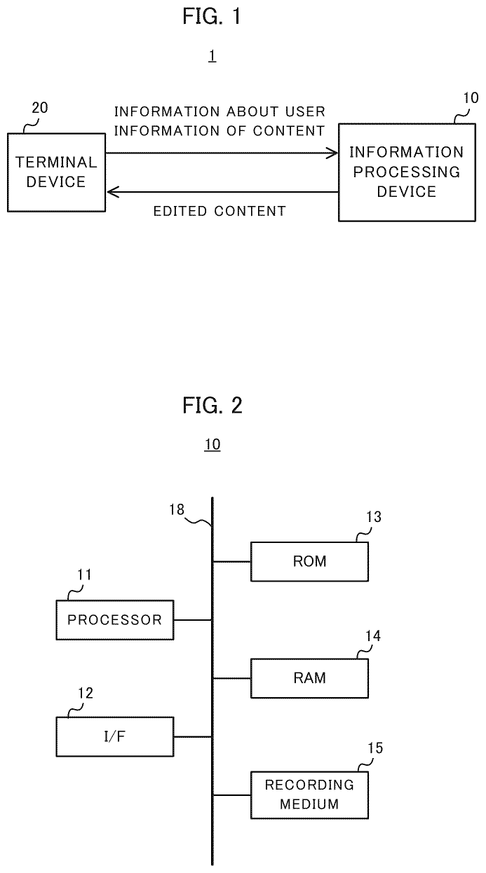

FIG. 1 shows an overall configuration of a content editing system to which an information processing device according to the present disclosure is applied. The content editing system 1 includes an information processing device 10 and a terminal device 20. The information processing device 10 and the terminal device 20 can communicate by wire or wireless. Incidentally, it is assumed that multiple terminal device 20 exist. Additionally, a user of terminal device 20 is assumed to have registered for the use of the content editing system in advance.

The terminal device 20 is operated by the user. The user can view WEB content and mobile content through the terminal device 20. In this embodiment, it is assumed that the viewers of the content are minors (children). When the user accesses content, the terminal device 20 transmits information about the user and information of the content to the information processing device 10. The information of the content is, for example, URL (Uniform Resource Locator) of the content.

The information processing device 10 edits the content accessed by the user and transmits the edited content (hereinafter also referred to as “edited content”) to the terminal device 20. Specifically, the information processing device 10 generates an instruction (hereinafter, also referred to as “prompt”) for a generative AI (Artificial Intelligence) based on the information about the user and the information of the content. The generated prompt includes instructions to edit the content and the content to be edited. The information processing device 10 inputs the generated prompt to the generative AI, and acquires an answer to the prompt from the generative AI. In the present embodiment, for example, large language model is used as the generative AI.

The information processing device 10 transmits the answer from the generative AI as the edited content to the terminal device 20. The terminal device 20 displays the edited content received from the information processing device 10 on the display instead of the content accessed by the user.

In this way, since the content editing system 1 edits the content using the information about the user, it is possible to provide the edited content according to the individual users.

### [Large Language Model]

A large language model used in the present embodiment will be described. The large language model (also referred to as a “language model”) is a model that learns the relationships between words in a sentence. The language model generates a string related to a target string. By using the language model that has learned from a variety of contexts and sentences, it is possible to generate strings with appropriate content related to the target string. As an example, the use case of the language model in a question-and-answer context will be described. The language model accepts the question “What kind of country is Japan?” as the target string. As the answer to the question, the language model generates strings such as “Japan is in an island country in the northern hemisphere . . . ”.

A learning method of the language model is not particularly restricted. For example, the language model may be trained to output at least one sentence that includes the input string. For example, the language model may be a GPT (Generative Pre-Training), which generates a sentence that includes the input string by predicting a high-probability string following the input string. In addition to this, for example, the language model may be T5 (Text-to-Text Transfer Transformer), BERT (Bidirectional Encoder Representations from Transformers), ROBERTa (Robustly Optimized BERT Approach), and ELECTRA (Efficiently Learning an Encoder that Classifies Token Replacements Accurately).

Also, the strings generated by the language model are not limited to natural languages. For example, the language model may generate artificial language (program source code, etc.) as output for a string input in natural language. For example, the language model accepts the question “How to acquire data containing a specific string from the database?” as the target string. Then, the language model may output the program source code for performing database processing. Alternatively, the language model may output natural language corresponding to a string input in artificial language.

Also, content generated by the language model is not limited to strings. For example, the language model may generate image data, moving image data, voice data, or data in other formats corresponding to the input string. Also, the data input to the language model is not limited to strings. For example, voice data may be input in the language model, and the language model may output a string based on the content of the voice data.

### [Hardware Configuration]

### (Information Processing Device)

FIG. 2 is a block diagram showing a hardware configuration of the information processing device 10. As shown, the information processing device 10 includes a processor 11, an interface (IF) 12, a ROM (Read Only Memory) 13, a RAM (Random Access Memory) 14, and a recording medium 15. Each component is connected, for example, through a bus 18.

The processor 11 is a computer such as a CPU (Central Processing Unit) and controls the entire information processing device 10 by executing a program prepared in advance. Specifically, the processor 11 may be a CPU, a GPU (Graphics Processing Unit), a DSP (Digital Signal Processor), a MPU (Micro Processing Unit), a FPU (Floating Point number Processing Unit), a PPU (Physics Processing Unit), a TPU (Tensor Processing Unit), a quantum processor, a microcontroller, or a combination thereof.

The processor 11 loads the program stored in the ROM 13 or the recording medium 15 and executes the processing coded in the program. The processor 11 also functions as part or all of the information processing device 10. The processor 11 executes the content editing processing to be described later.

The IF 12 transmits and receives data to and from external devices. Specifically, the information processing device 10 receives information about the user and information of the content from the terminal device 20 through the IF 12. Further, the information processing device 10 transmits the edited content to the terminal device 20 through the IF 12.

The ROM 13 stores various programs executed by the processor 11. The RAM 14 is also used as a working memory during the execution of various processing by the processor 11.

The recording medium 15 is a non-volatile and non-transitory recording medium such as a disk-type recording medium, a semiconductor memory, or the like. The recording medium 15 may be configured to be detachable from the information processing device 10. The recording medium 15 records various programs executed by the processor 11. The recording medium 15 may include a database for recording reader information as described below, or a database for recording edited content, and a document set. The recording medium 15 may store a machine learning model or the like.

In addition to the above, the information processing device 10 may include a display device such as a liquid crystal display or a projector, and an input device such as a keyboard or a mouse. These display devices and input devices are used by the manager of the information processing device 10 to perform the necessary management, for example.

### (Terminal Device)

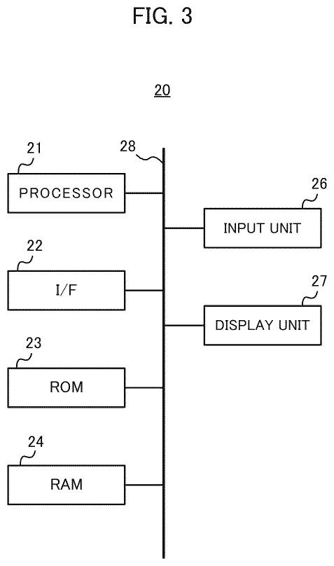

FIG. 3 is a block diagram showing a hardware configuration of the terminal device 20. For example, the terminal device 20 is a smartphone, or the like. As shown, the terminal device 20 includes a processor 21, an IF 22, a ROM 23, a RAM 24, an input unit 26, and a display unit 27. Each component is connected, for example, through a bus 28.

The processor 21 is a computer such as a CPU, and controls the entire terminal device 20 by executing a program prepared in advance. The processor 21 may be a GPU, FPGA, DSP, ASIC or the like.

The IF 22 transmits and receives data to and from external devices. Specifically, the terminal device 20 transmits information about the user and information of the content to the information processing device 10 through the IF 22. The terminal device 20 receives the edited content from the information processing device 10 through the IF 22.

The ROM 23 stores various programs executed by the processor 21. The RAM 24 is also used as a working memory during the execution of various processing by the processor 21.

The input unit 26 is, for example, an input device such as a touch panel or a microphone. The display unit 27 may include a display that performs display and a speaker that performs audio output based on the control of the processor 21.

### [Functional Configuration]

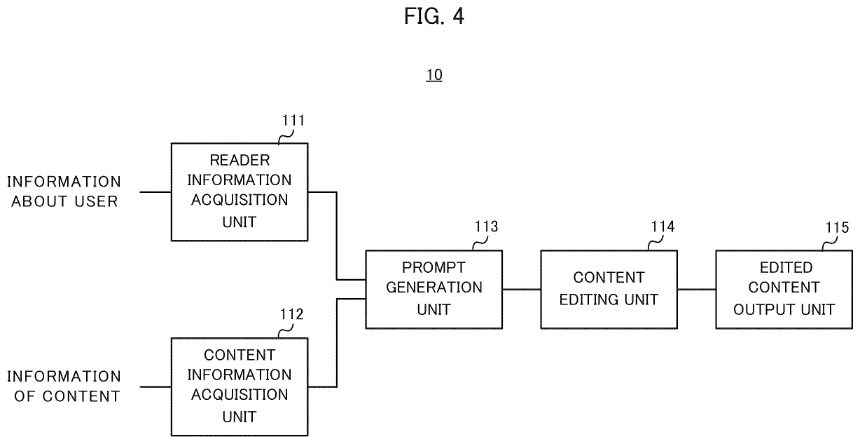

FIG. 4 is a block diagram illustrating a functional configuration of the information processing device 10 according to the first example embodiment. The information processing device 10 functionally includes a reader information acquisition unit 111, a content information acquisition unit 112, a prompt generation unit 113, a content editing unit 114, and an edited content output unit 115.

The reader information acquisition unit 111 acquires information about the user from the terminal device 20. Then, the reader information acquisition unit 111 estimates various pieces of information (hereinafter also referred to as ‘reader information’), including “age group,” “favorite characters or themes,” “favorite content formats,” “past browsing history,” “feedback or evaluation,” “reader's regional or cultural background (also simply referred to as a “reader's cultural background”),” and “requests from parents,” based on the information about the user. The reader information acquisition unit 111 outputs the reader information to the prompt generation unit 113.

In the above description, the information processing device 10 estimates the reader information, but instead, the terminal device 20 may estimate the reader information. In this case, the terminal device 20 transmits the reader information to the information processing device 10 instead of the information about the user.

The content information acquisition unit 112 acquires the information of the content accessed by the user from the terminal device 20. The content information acquisition unit 112 acquires the corresponding content based on the information of the content and outputs the acquired content to the prompt generation unit 113. For example, when the information of the content is URL, the content information acquisition unit 112 acquires the content corresponding to the linked URL and outputs the acquired content to the prompt generation unit 113. The content information acquisition unit 112 outputs the content to the prompt generation unit 113.

The prompt generation unit 113 generates a prompt based on the reader information input from the reader information acquisition unit 111 and the content input from the content information acquisition unit 112. For example, the prompt includes an “instruction section” that provides the model with tasks or instructions to be performed, and a “context section” that provides the model with information needed to generate an answer. The “instruction section” is generated based on the reader information. For example, the prompt generation unit 113 generates an instruction such as “Please create a story for an 8-year-old, based on the following content” based on the reader information. The “context section” is also generated to include the content. The prompt generation unit 113 outputs the generated prompt to the content editing unit 114.

The content editing unit 114 acquires the prompt from the prompt generation unit 113. The content editing unit 114 inputs the prompt to the generative AI and acquires the answer to the prompt from the generative AI. The generative AI edits the content included in the input prompt according to the instruction included in the prompt, and outputs the edited content as an answer. The content editing unit 114 outputs the edited content to the edited content output unit 115. The edited content output unit 115 outputs the edited content to the terminal device 20.

In the above-described configuration, the reader information acquisition unit 111 and the content information acquisition unit 112 are example of an acquisition means, the prompt generation unit 113 is an example of a prompt generation means, the content editing unit 114 and the edited content output unit 115 are example of a content editing means.

### [Example of Reader Information]

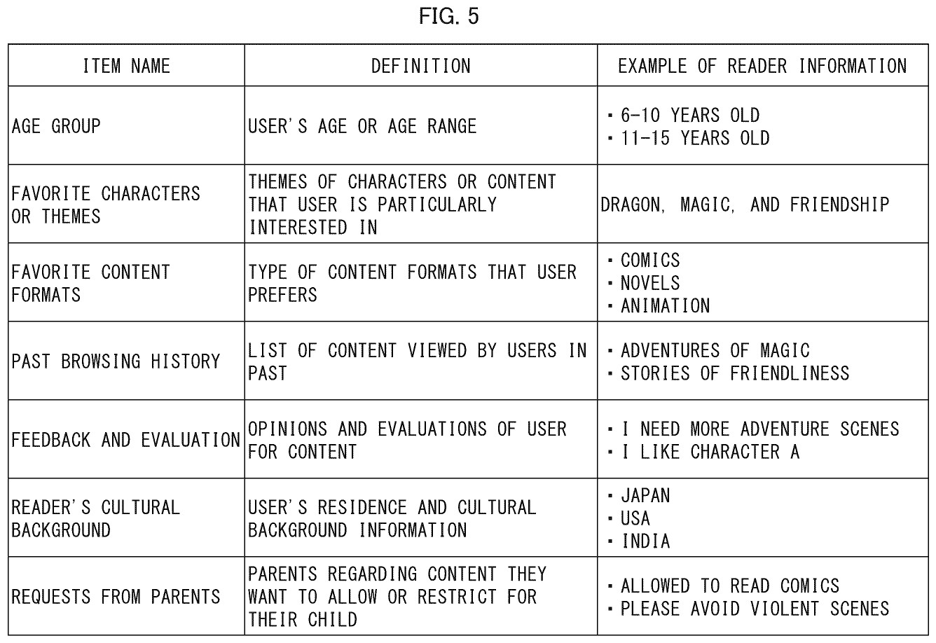

Next, the reader information estimated by the reader information acquisition unit 111 will be described. FIG. 5 shows an example of the reader information corresponding to each item of “age group,” “favorite characters or themes,” “favorite content formats,” “past browsing history,” “feedback and evaluation,” “reader's cultural background,” and “requests from parents.”

The “age group” is the user's age or age range. In FIG. 5, examples of the “age group” include age ranges such as “6-10 years old” and “11-15 years old.” The reader information acquisition unit 111 can estimate the age group from the registration information at the time of use registration of the user. If the age is not entered at the time of use registration, the reader information acquisition unit 111 can detect the content that interests the user, based on the application usage history, the browsing history of websites or the search history of websites, and then the reader information acquisition unit 111 can estimate the age group from the target group for the content.

The “favorite characters or themes” is the themes of the characters or content that the user is particularly interested in. In FIG. 5, examples of the “favorite characters or themes” include “Dragon, Magic, and Friendship.” For example, the reader information acquisition unit 111 can estimate the user's favorite characters or themes based on the browsing history, the search history, the favorite data, or the bookmark data of websites.

The “favorite content formats” is the type of content formats that the user prefers. In FIG. 5, examples of the “favorite content formats” include “Comics,” “Novels,” and “Animation.” For example, the reader information acquisition unit 111 can estimate the content formats that the user prefers based on access data such as viewing time on websites, number of visits to websites, and download counts of web content.

The “past browsing history” is a list of content viewed by users in the past. In FIG. 5, examples of the “past browsing history” include titles of stories such as “adventures of magic” and “stories of friendliness.” For example, the reader information acquisition unit 111 may generate a list of content that the user has viewed in the past based on browser cookies, session data, and application usage history.

The “feedback and evaluation” is opinions and evaluations of the user for the content. In FIG. 5, examples of the “feedback and evaluation” include “I need more adventure scenes” and “I like character A.” For example, the reader information acquisition unit 111 can estimate the feedback or the evaluation based on comments, reviews, and evaluation scores that the user has provided for the content.

The “reader's cultural background” is the user's residence and cultural background information. In FIG. 5, examples of the “reader's cultural background” include national names such as “Japan”, “USA”, and “India”. For example, the reader information acquisition unit 111 can identify the user's residential area based on the IP address of the terminal device 20 and GPS information. Further, the reader information acquisition unit 111 can estimate the cultural background of the user from the language setting of the terminal device 20.

The “requests from parents” refers to preferences or restrictions of the contents that the parents want to allow or restrict for their child. In FIG. 5, examples of “requests from parents” include “Allowed to read comics” and “Please avoid violent scenes.” For example, the reader information acquisition unit 111 can estimate the requests from parents based on setting information, such as filtering and function restrictions set on the terminal device 20, as well as questionnaire responses and feedback from the parents, or the like. The reader information acquisition unit 111 may estimate the requests from parents by analyzing the settings for access restrictions on specific content.

### [Prompt Generation Method]

Next, prompt generation method by the prompt generation unit 113 will be described. The prompt generation unit 113 can generate the prompt using the machine learning model. This machine learning model is generated by machine learning, for example, using a pair of reader information (age, favorite characters and themes, etc.) and prompts generated based on the reader information as training data. The prompt generation unit 113 can generate the optimum prompt by inputting new reader information into the machine learning model.

The prompt generation unit 113 may generate the prompt according to a predetermined rule. For example, the above rule includes criteria based on age, such as “if the user is 10 years old or younger, add a phrase ‘story for children’ to the prompt.”

The prompt generation unit 113 may generate the prompt by using an ontology, a knowledge graph, or the like. For example, the prompt generation unit 113 organizes knowledge and information related to the reader information hierarchically, using external knowledge. Then, the prompt generation unit 113 generates the knowledge graph. Then, the prompt generation unit 113 extracts information related to the reader information from the knowledge graph, and generates the prompt based on the reader information and the extracted information. For example, if the user's “favorite characters or themes” includes a “dragon”, the prompt generation unit 113 extracts “fantasy” which is the superordinate concept of “dragon” from the knowledge graph. Then, the prompt generation unit 113 generates the prompt such as “Please generate an adventure story about dragon in a fantasy world”.

The prompt generation unit 113 may also provide the generated prompt to the user, and edit the prompt based on the reaction or feedback of the user. For example, the prompt generation unit 113 generates the prompt “Please generate an adventure story,” and provides it to the user. Then, when the user provides feedback saying, “I want to see more magic adventure stories,” the prompt generation unit 113 edits the prompt to “Please generate a magic adventure story.”

### [Example of Generated Prompt]

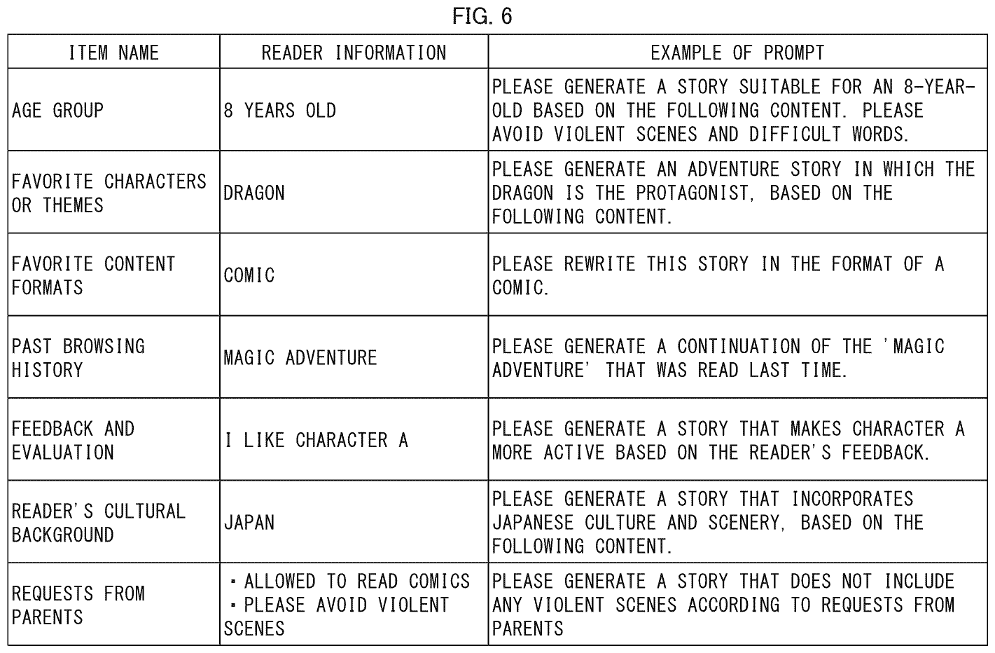

Next, the prompt generated by the prompt generation unit 113 will be described. FIG. 6 shows an example of the prompt generated based on the information for each item. Each item includes “age group,” “favorite characters or themes,” “favorite content formats,” “past browsing history,” “feedback and evaluation,” “reader's cultural background,” and “requests from parents.”

The “age group” is used to provide the age-appropriate content, such as by filtering out violent expressions. In the example shown in FIG. 6, the user's age is 8 years old. The prompt generation unit 113 generates the following prompt based on the user's age: “Please generate a story suitable for an 8-year-old based on the following content. Please avoid violent scenes and difficult words.”

The “favorite characters or themes” are used to customize content to suit user preferences. In the example shown in FIG. 6, the user's favorite character is a dragon. The prompt generation unit 113 generates the following prompt based on the user's favorite character: “Please generate an adventure story in which the dragon is the protagonist, based on the following content.”

The “favorite content formats” are used to adjust the content format to the user's preferences. In the example shown in FIG. 6, the user's favorite content format is a comic. The prompt generation unit 113 generates the following prompt based on the user's favorite content format: “Please rewrite this story in the format of a comic.”

The “past browsing history” is used to analyze users' interests and preferences and to recommend a new content. In the example shown in FIG. 6, the past browsing history includes a story titled “Magic Adventure.” The prompt generation unit 113 generates the following prompt based on the past browsing history: “Please generate a continuation of the ‘Magic Adventure’ that was read last time.”

The “feedback or evaluation” is used to improve the quality of the content. Also, “feedback or evaluation” is used to generate the content tailored to the needs of the user. In the example shown in FIG. 6, the user provides feedback: “I like character A.” The prompt generation unit 113 generates the following prompt based on the feedback: “Please generate a story that makes character A more active based on the reader's feedback.”

The “reader's cultural background” is used to tailor content to the countries, regions, and culture in which users live. In the example shown in FIG. 6, the user lives in Japan. The prompt generation unit 113 generates the following prompt based on the country in which users live: “Please generate a story that incorporates Japanese culture and scenery, based on the following content.”

The “requests from parents” is used to provide the content that aligns with parents' wishes. In the example shown in FIG. 6, the requests from parents are “Allowed to read comics” and “Please avoid violent scenes.” The prompt generation unit 113 generates the following prompt based on the requests from parents: “Please generate a story that does not include any violent scenes according to requests from parents.”

In the description above, although the prompt generation unit 113 generates a prompt based on a single item, multiple items may be combined to generate a prompt.

### [Example of Edited Content]

Next, an example of the edited content will be described. Now, it is assumed that a user in a younger age group has accessed content containing the violent expressions through the terminal device 20.

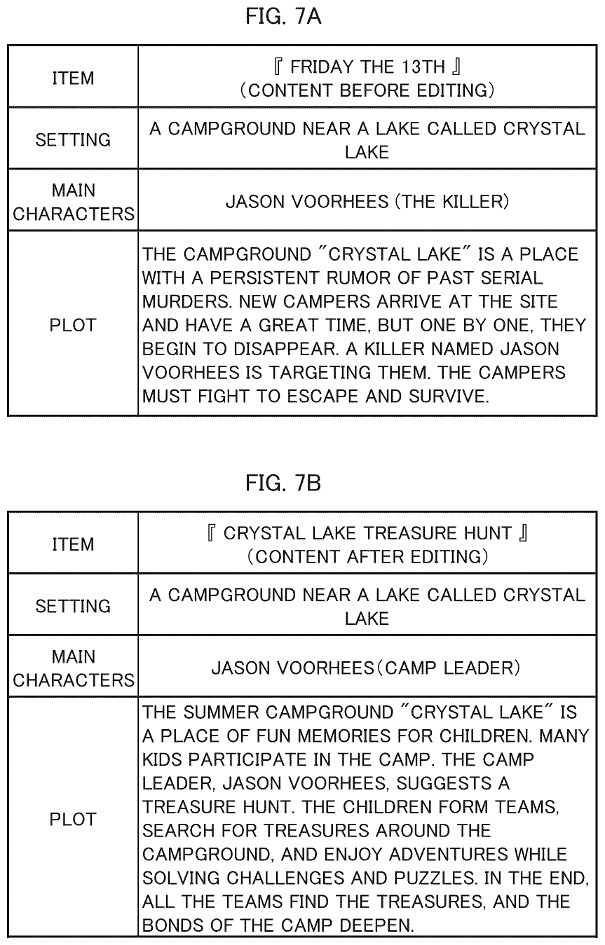

FIG. 7 shows content before editing and content after editing. FIG. 7A shows the content before editing. The content before editing includes story about “killer.” FIG. 7B shows the content after editing which is edited by the information processing device 10. In the content after editing, the story about “killer” has been edited to the story about “treasure hunt”. In this way, the information processing device 10 replaces the undesirable expression with another expression and transmits it to the terminal device 20. Thus, the user of the terminal device 20 can avoid contact with harmful information.

### [Content Editing Processing]

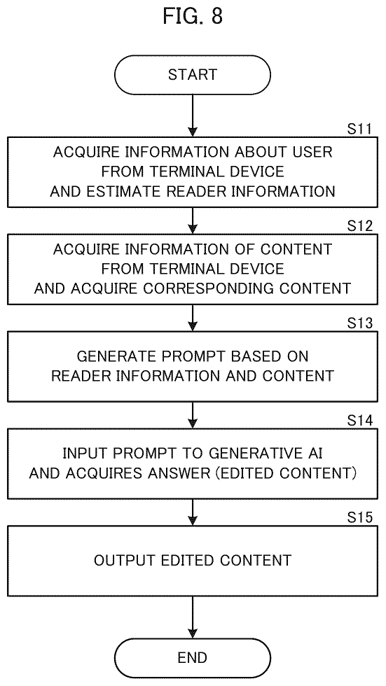

Next, the content editing processing will be described. FIG. 8 is a flowchart of content editing processing performed by the information processing device 10. This processing is realized by the processor 11 shown in FIG. 2, executing a pre-prepared program and operating as each element shown in FIG. 4.

First, the reader information acquisition unit 111 acquires information about the user from the terminal device 20. Then, the reader information acquisition unit 111 estimates the reader information based on the information about the user (step S11). The reader information acquisition unit 111 outputs the reader information to the prompt generation unit 113. Next, the content information acquisition unit 112 acquires information of the content accessed by the user from the terminal device 20. The content information acquisition unit 112 acquires the corresponding content based on the information of the content (step S12). The content information acquisition unit 112 outputs the content to the prompt generation unit 113.

Next, the prompt generation unit 113 generates the prompt based on the reader information input from the reader information acquisition unit 111 and the content input from the content information acquisition unit 112 (step S13). The prompt generation unit 113 outputs the generated prompt to the content editing unit 114. Next, the content editing unit 114 inputs the prompt to the generative AI and acquires the answer to the prompt from the generative AI (step S14). The generative AI edits the content included in the input prompt according to the instruction included in the prompt, and outputs the edited content as an answer. The content editing unit 114 outputs the edited content to the edited content output unit 115. Next, the edited content output unit 115 outputs the edited content to the terminal device 20 (step S15). Then, the processing ends.

### [Modification]

Next, a modification of the first example embodiment will be described. The information processing device 10 of this embodiment can be applied to adaptive parental controls or the like. Adaptive parental control is a function that appropriately manages children's (minors') access to Internet content based on criteria set by parents.

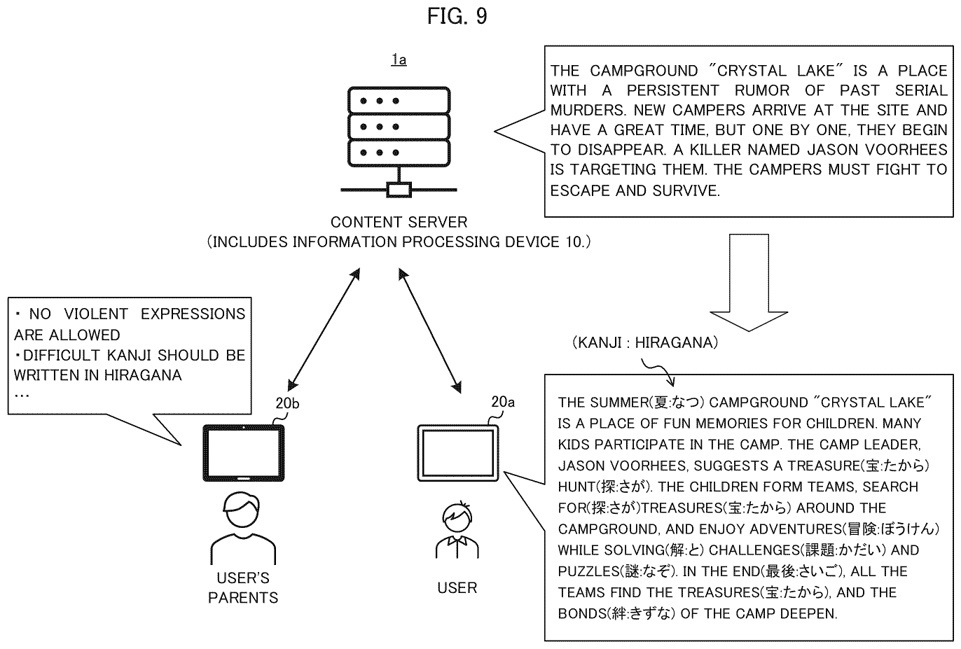

FIG. 9 shows an overall configuration of a content editing system 1a in the modification. In FIG. 9, the content editing system 1a includes a content server that provides content, a terminal device 20a used by the user, and a terminal device 20b used by the user's parents. The content server includes the information processing device 10.

The user's parents set the user's attributes or specific instructions and transmit the setting to the content server via the terminal device 20b. The user connects to the content server and browses the content via the terminal device 20a. At this time, the information processing device 10 within the content server dynamically edits the content to be viewed by the user based on the setting received from the terminal device 20b.

For example, if the user's parents restrict access to content related to specific keywords or themes, the content containing those keywords or themes will not be displayed on the terminal device 20a. In FIG. 9, the content server changes violent expressions to other expressions based on the restriction from the user's parents that “no violent expressions are allowed” and transmits it to the terminal device 20a. In addition, the content server may convert kanji to hiragana or generate illustrations. In FIG. 9, the content server adds furigana in parentheses next to kanji based on the restriction from the user's parents that “difficult kanji should be written in hiragana” and transmits it to the terminal device 20a. With this function, the content editing system 1a can flexibly control content browsing on the Internet according to each household's values and the protector's intentions.

### Second Example Embodiment

Next, the second example embodiment will be described. The information processing device 10a of the second example embodiment can generate text content based on image content such as comics. Note that the overall configuration and the hardware configuration of the information processing device 10a are the same as those of the information processing device 10 of the first example embodiment, so the description thereof will be omitted.

### [Function Configuration]

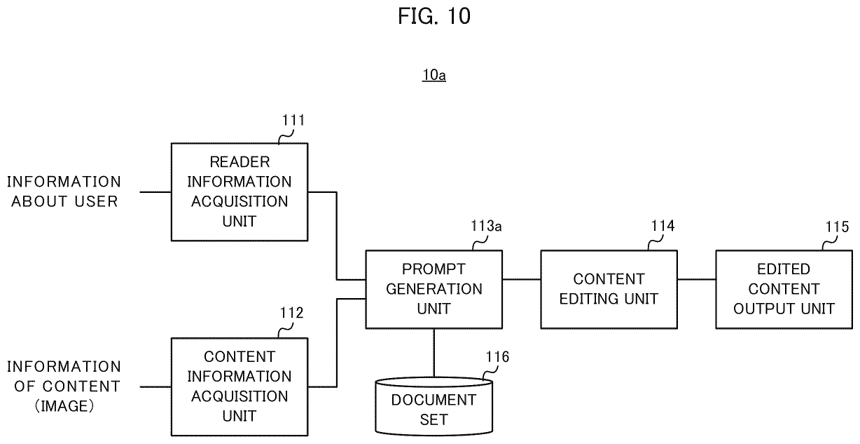

FIG. 10 is a block diagram illustrating a functional configuration of the information processing device 10a according to the second example embodiment. The information processing device 10a functionally includes a reader information acquisition unit 111, a content information acquisition unit 112, a prompt generation unit 113a, a content editing unit 114, an edited content output unit 115, and a document set 116. The document set 116 is implemented by the recording medium 15 shown in FIG. 2. The reader information acquisition unit 111, the content information acquisition unit 112, the prompt generation unit 113a, the content editing unit 114, and the edited content output unit 115 are configured by the processor 11 shown in FIG. 2.

Since the reader information acquisition unit 111, the content information acquisition unit 112, the content editing unit 114, and the edited content output unit 115 have the same configuration as the information processing device 10 according to the first example embodiment and operate in the same manner, the description thereof will be omitted.

The prompt generation unit 113a acquires the reader information from the reader information acquisition unit 111 and acquires the image content from the content information acquisition unit 112.

The prompt generation unit 113a generates a text similar to the image content (hereinafter, also referred to as “similar text”) by using a method of generating the similar text which will be described later. The prompt generation unit 113a generates a prompt based on the reader information and the similar text. The “instruction section” of the prompt is generated based on the reader information in the same way as the first example embodiment. The “context section” is generated to contain the similar text. The prompt generation unit 113a outputs the generated prompt to the content editing unit 114.

### [Similar Text Generation Method]

Next, the similar text generation method by the prompt generation unit 113a will be described. The prompt generation unit 113a extracts keywords and explanatory text related to the image content. The prompt generation unit 113a generates the similar text by searching and extracting text similar to the keywords and the explanatory text.

### (Extraction Method for Keywords and Explanatory Text)

First, the prompt generation unit 113a recognizes the objects included in the image content by using the image recognition techniques. For example, the prompt generation unit 113a identifies specific objects or scenes using an existing semantic segmentation model. For example, the existing semantic segmentation model include U-Net, DeepLabV3, PSPNet or the like. The prompt generation unit 113a extracts keywords and explanatory text related to the image content based on the recognized objects and scenes. For example, the prompt generation unit 113a extracts keywords such as “tree” and “house” based on the recognized objects.

### (Extraction Method for Similar Text)

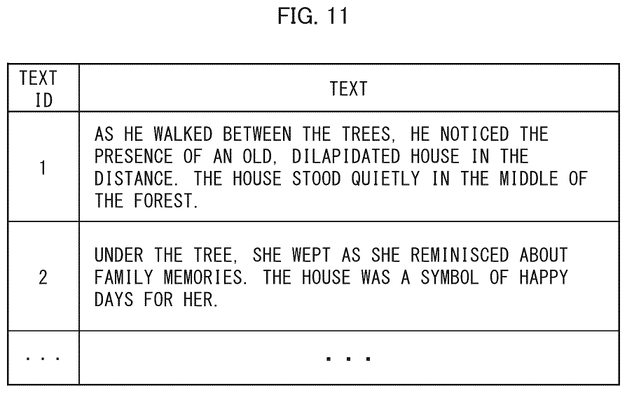

Next, the prompt generation unit 113a searches and extracts text similar to the keywords or the explanatory text from the document set 116. FIG. 11 is an example of the document set 116. The document set 116 is a collection of documents consisting of multiple story texts or the like, and includes a unique text ID for each text as well as the text itself.

Specifically, the prompt generation unit 113a calculates the importance of words contained in each text of the document set 116 using TF-IDF (Term Frequency-Inverse Document Frequency). Then, the prompt generation unit 113a compares the similarity between the important words of each text and the keywords, and extracts the text containing the most similar important words as the similar text. For example, the prompt generation unit 113a uses cosine similarity to calculate the similarity. The prompt generation unit 113a uses a vector space model to calculate the angle between the vectors of the important words in each text and the keywords, and determines the similarity.

The prompt generation unit 113a may also represent words contained in each text of the document set 116 as the vectors using word embedding techniques, and calculate the similarity between the words and the keywords. The prompt generation unit 113a extracts the text containing the words with the highest similarity as the similar text. For example, the word embedding techniques include Word2Vec and GloVe.

The prompt generation unit 113a may represent each text in the document set 116 and the keywords as vectors using a Transformer-based model, and calculate their similarity. The prompt generation unit 113a extracts the text with the highest similarity to the keywords as the similar text. For example, Transformer-based model includes BERT and ROBERTa. The prompt generation unit 113a may extract the text semantically related to the keywords from the document set 116 as the similar text using LSI (Latent Semantic Indexing).

### [Content Editing Processing]

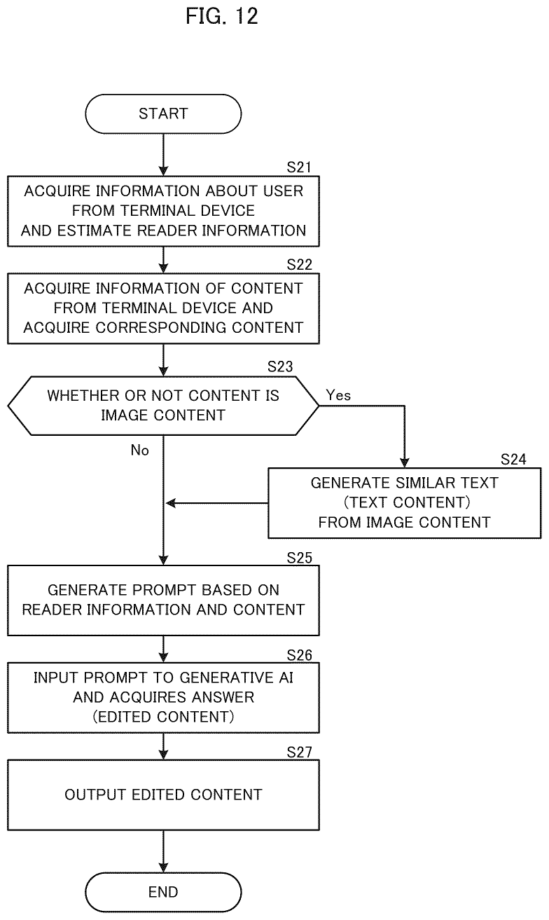

Next, the content editing processing of the second example embodiment will be described. FIG. 12 is a flowchart of content editing processing performed by the information processing device 10a. This processing is realized by the processor 11 shown in FIG. 2, executing a pre-prepared program and operating as each element shown in FIG. 10. Since the processing of the step S21˜S22 and S25˜S27 is the same as the processing of the step S11˜S15 of the first example embodiment shown in FIG. 8, the description thereof will not be repeated.

The prompt generation unit 113a determines whether or not the content acquired from the content information acquisition unit 112 is image content (step S23). When the content is image content (step S23: Yes), the prompt generation unit 113a generates the similar text from the image content (step S24). Specifically, the prompt generation unit 113a generates the similar text by searching and extracting text similar to the keywords and the explanatory text related to the image content. On the other hand, when the content is not image content (step S23: No), the processing proceeds to step S25.

As described above, the information processing device 10a of the second example embodiment can generate the text content based on the image content, such as the comics. This makes it possible to respond to the requests from parents that “comics are not good but novels are good.”

### Third Example Embodiment

Next, the third example embodiment will be described. The information processing device 10b of the third example embodiment generates edited content based on user's speech and outputs the edited content with voice. Note that the overall configuration and the hardware configuration of the information processing device 10b are the same as those of the information processing device 10 of the first example embodiment, so the description thereof will be omitted.

### [Function Configuration]

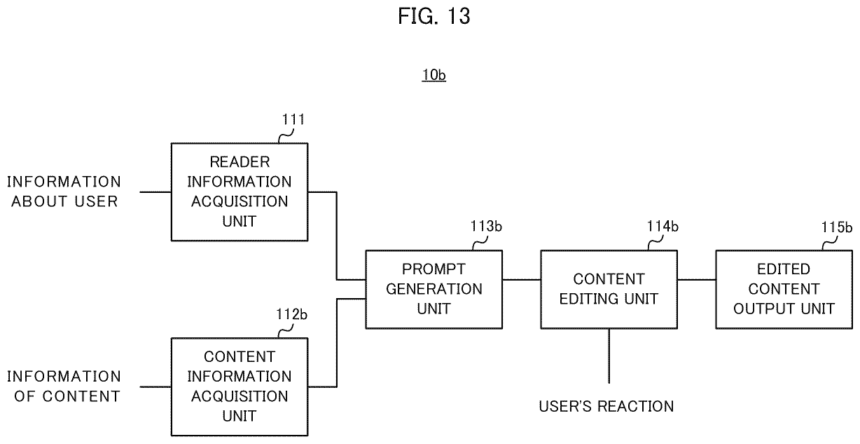

FIG. 13 is a block diagram illustrating a functional configuration of the information processing device 10b according to the third example embodiment. The information processing device 10b functionally includes a reader information acquisition unit 111, a content information acquisition unit 112b, a prompt generation unit 113b, a content editing unit 114b, and an edited content output unit 115b. Since the reader information acquisition unit 111 has the same configuration as the information processing device 10 according to the first example embodiment and operates in the same manner, the description thereof will be omitted.

The terminal device 20 capture the user's speech and the like and transmits it to the information processing device 10b. For example, the user makes requests such as “play the video of XX” or “read the story of XX” to the terminal device 20. The terminal device 20 transmits the speech data uttered by the user to the information processing device 10b.

The speech data of the user received from the terminal device 20 is input to the content information acquisition unit 112b. For example, the content information acquisition unit 112b recognizes the speech in speech data using a speech recognition model. The content information acquisition unit 112b searches for the corresponding content on website or similar sources on the recognized speech and acquires the corresponding content. The content information acquisition unit 112b outputs the acquired content to the prompt generation unit 113b.

The prompt generation unit 113b generates a prompt based on the reader information and the content. The “instruction section” of the prompt is generated based on the reader information in the same way as the first example embodiment. The “context section” is also generated to include the content. If the content is video content, the prompt generation unit 113b may include the audio file of the video directly in the context section. Alternatively, the prompt generation unit 113b may use a speech recognition model to transcribe the audio from the video into text and include it in the context section of the prompt. For example, the speech recognition model is generated by training a neural network with a dataset that consists of pairs of speaker's speech and their corresponding text information. The prompt generation unit 113b outputs the generated prompt to the content editing unit 114b.

The content editing unit 114b acquires the prompt from the prompt generation unit 113b. The content editing unit 114b inputs the prompt to the generative AI and acquires the answer to the prompt from the generative AI. The content editing unit 114b outputs the edited content to the edited content output unit 115b. The edited content output unit 115b outputs the edited content as voice to the terminal device 20.

The content editing 114b may also generate a response based on the user's reaction to the edited content. The terminal device 20 transmits speech data showing a user's reaction to the edited content, such as “What is the punchline?” or “What does XX mean?” (hereinafter, referred to as “reaction information”) to the information processing device 10b. The reaction information received from the terminal device 20 is input to the content editing unit 114b. The content editing unit 114b inputs the reaction information into the generative AI and acquires the response to the reaction information from the generative AI. Then, the content editing unit 114b outputs the response to the reaction information to the edited content output unit 115b. The edited content output unit 115b outputs the response to the reaction information as voice to the terminal device 20.

As described above, the information processing device 10b of the third example embodiment can provide the edited content in an interactive format with the user. Thus, the information processing device 10b can provide the edited content to the users in younger age groups who are unable to operate the terminal device manually. For example, the information processing device 10b can direct the user's interest to the content while the user's parents are doing housework. In addition, the information processing device 10b can provide edited content to patients who are required to remain at rest in the field of medical healthcare.

### [Modification]

Next, a modification of the present embodiment will be described. The following modifications can be arbitrarily combined and applied to the above example embodiment.

### (Modification 1)

The information processing device 10b according to the third example embodiment may include instructions in the prompt to output refined language. For example, the refined language refers to language that does not include slang. The content editing unit 114b includes instructions such as “Please use refined Japanese” to the “instruction section” of the prompt. Since users can listen to content with refined language, their parents can allow them to use the content without any feelings of guilt.

### (Modification 2)

The information processing device 10b according to the third example embodiment may disclose the edited content to other users. The information processing device 10b may disclose all the edited content generated, or may disclose only high-quality edited content. The high-quality edited content refers to edited content that captivates the user's interest, among other things. For example, the information processing device 10b accumulates the edited content uploaded by the user's parents as edited content that captivates the user's interest. Then, the information processing device 10b shares the accumulated edited content with other users. Thus, the user can share the edited content with other users.

The information processing device 10b may generate new content by using the edited content with a high reproduction frequency from among the disclosed edited content. The information processing device 10b selects multiple pieces of edited content based on the reproduction frequency of the edited content. Then, the information processing device 10b generates new edited content by including a combination of the selected multiple pieces of edited content in the context section of the prompt. Thus, the likelihood of generating better content is increased.

In the above description, the information processing device 10b generates the new content based on the edited content with a high reproduction frequency, but instead, the new content may be generated based on the edited content selected by the user or the user's parents. Specifically, the user or the user's parents selects multiple pieces of edited content from among the disclosed edited content. Then, the information processing device 10b generates new edited content by including a combination of the selected multiple pieces of edited content in the context section of the prompt. Thus, the likelihood of generating better content that matches the preferences of the user and the user's parents is increased.

### Fourth Example Embodiment

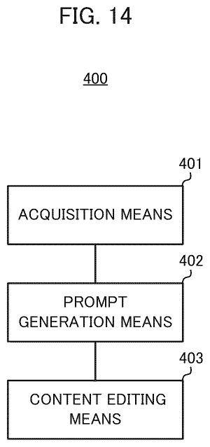

FIG. 14 is a block diagram illustrating a functional configuration of an information processing device according to the fourth example embodiment. The information processing device 400 includes an acquisition means 401, a prompt generation means 402, and a content editing means 403.

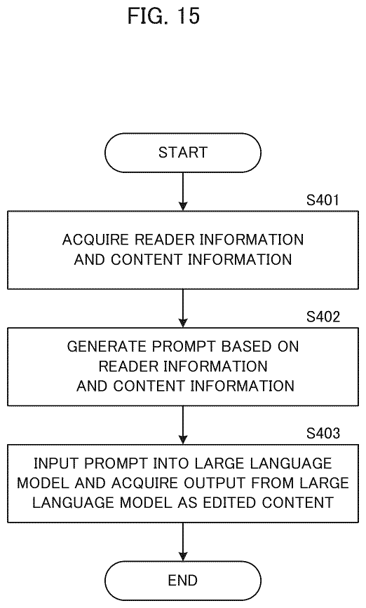

FIG. 15 is a flowchart of processing by the information processing device according to the fourth example embodiment. The acquisition means 401 acquires reader information and content information (step S401). The prompt generation means 402 generates a prompt based on the reader information and the content information (step S402). The content editing means 403 inputs the prompt into a large language model and acquire an output from the large language model as edited content (step S403).

According to the information processing device 400 of the fourth example embodiment, it is possible to edit content by reflecting user's information. Further, the information processing device 400 can perform optimization of the content.

A part or all of the example embodiments described above may also be described as the following supplementary notes, but not limited thereto.

### (Supplementary Note 1)

An information processing device comprising:
an acquisition means configured to acquire reader information and content information;
a prompt generation means configured to generate a prompt based on the reader information and the content information; and
a content editing means configured to input the prompt into a large language model and acquire an output from the large language model as edited content.

### (Supplementary Note 2)

The information processing device according to Supplementary note 1, wherein the content information is text content.

### (Supplementary Note 3)

The information processing device according to Supplementary note 1, wherein the content information is image content, and
wherein the prompt generation means generates a similar text similar to the image content based on the image content and generates the prompt based on the reader information and the similar text.

### (Supplementary Note 4)

The information processing device according to Supplementary note 3, further comprising a text storage configured to store multiple texts,
wherein the processor generates the similar text by extracting keywords or explanatory text related to the image content using image recognition techniques and extracting the similar text similar to the keywords and the explanatory text from the text storage.

### (Supplementary Note 5)

The information processing device according to Supplementary note 2, further comprising an output means configured to output the edited content to the terminal device of the user,
wherein the output means outputs the edited content as voice.

### (Supplementary Note 6)

The information processing device according to Supplementary note 5,
wherein the processor is further configured to store the edited content in edited content storage,
wherein the processor stores edited content uploaded by the user, and
wherein the processor generates the prompt based on the reader information and any combination of edited content stored in the edited content storage.

### (Supplementary Note 7)

The information processing device according to Supplementary note 6, further comprising a disclosure means configured to disclose the edited content to other users,
wherein the disclosure means discloses the edited content stored in the edited content storage.

### (Supplementary Note 8)

The information processing device according to Supplementary note 7, wherein the prompt generation means generates the prompt based on the reader information and any combination of edited content that has a reproduction frequency equal to or exceeding a predetermined threshold value from among the disclosed edited content.

### (Supplementary Note 9)

An information processing method comprising:
acquiring reader information and content information;
generating a prompt based on the reader information and the content information; and
inputting the prompt into a large language model and acquiring an output from the large language model as edited content.

### (Supplementary Note 10)

A recording medium storing a program, the program causing a computer to execute processing of:
acquiring reader information and content information;
generating a prompt based on the reader information and the content information; and
inputting the prompt into a large language model and acquiring an output from the large language model as edited content.

While the present invention has been described with reference to the example embodiments and examples, the present invention is not limited to the above example embodiments and examples. Various changes which can be understood by those skilled in the art within the scope of the present invention can be made in the configuration and details of the present invention.

This application is based upon and claims the benefit of priority from Japanese Patent Application 2023-175843, filed on Oct. 11, 2023, the disclosure of which is incorporated herein in its entirety by reference.

### DESCRIPTION OF SYMBOLS

10 Information processing device
111 Reader information acquisition unit
112 Content information acquisition unit
113 Prompt generation unit
114 Content editing unit
115 Edited content output unit
116 Document set

1. An information processing device comprising:
a memory configured to store instructions; and
a processor configured to execute the instructions to:
acquire reader information and content information;
generate a prompt based on the reader information and the content information; and
input the prompt into a large language model and acquire an output from the large language model as edited content.

2. The information processing device according to claim 1, wherein the content information is text content.

3. The information processing device according to claim 1,
wherein the content information is image content, and
wherein the processor generates a similar text similar to the image content based on the image content and generates the prompt based on the reader information and the similar text.

4. The information processing device according to claim 3, further comprising a text storage configured to store multiple texts,
wherein the processor generates the similar text by extracting keywords or explanatory text related to the image content using image recognition techniques and extracting the similar text similar to the keywords and the explanatory text from the text storage.

5. The information processing device according to claim 2,
wherein the processor is further configured to output the edited content to the terminal device of the user, and
wherein the processor outputs the edited content as voice.

6. The information processing device according to claim 5,
wherein the processor is further configured to store the edited content in edited content storage,
wherein the processor stores edited content uploaded by the user, and
wherein the processor generates the prompt based on the reader information and any combination of edited content stored in the edited content storage.

7. The information processing device according to claim 6,
wherein the processor is further configured to disclose the edited content to other users, and
wherein the processor discloses the edited content stored in the edited content storage.

8. The information processing device according to claim 7, wherein the processor generates the prompt based on the reader information and any combination of edited content that has a reproduction frequency equal to or exceeding a predetermined threshold value from among the disclosed edited content.

9. An information processing method comprising:
acquiring reader information and content information;
generating a prompt based on the reader information and the content information; and
inputting the prompt into a large language model and acquiring an output from the large language model as edited content.

10. A non-transitory computer-readable recording medium storing a program, the program causing a computer to execute processing of:
acquiring reader information and content information;
generating a prompt based on the reader information and the content information; and
inputting the prompt into a large language model and acquiring an output from the large language model as edited content.
